(19) United States
(12) Patent Application Publication
(10) Pub. No.: US 2014/0064888 A1
(43) Pub. Date: Mar. 6, 2014

(54) APPARTAUS FOR HANDLING AN ELECTRONIC DEVICE AND RELATED METHODOLOGY

(71) Applicant: Vico Chen, Zhonghe (TW)

(72) Inventor: Vico Chen, Zhonghe (TW)

(73) Assignee: TEXAS INSTRUMENTS INCORPORATED, Dallas, TX (US)

(21) Appl. No.: 13/605,802

(22) Filed: Sep. 6, 2012

(51) Int. Cl. B65G 1/06; B25J 15/00

(52) U.S. Cl. 414/280; 414/807; 294/86.4

(57) ABSTRACT

A handling device may include a frame and a carriage movably mounted on the frame. A clip assembly may be attached to the carriage and be adapted to frictionally engage a portion of an electronic device. The handling device may include at least one slot guide member attached to the frame. The slot guide member is adapted to engage within one of a plurality of slots of a magazine for holding electronic devices.

### BACKGROUND

Typical integrated circuit devices contain multiple printed circuit layers. Each layer is insulated from its adjacent layer except where interlayer connections are selectively created. The individual circuit layers of an integrated circuit device are typically created by a photolithographic process. Each layer is formed on an integrated circuit device during a separate trip through the photolithographic manufacturing area. After each trip, the integrated circuit device is transported to other manufacturing areas where additional processing steps, such as etching and deposition, are performed. Thereafter, the integrated circuit device is returned to the photolithographic process manufacturing area so that an additional circuit layer may be applied. The process is then repeated until the desired number of circuit layers has been created.

During the manufacture of integrated circuit devices, several devices are typically formed on a single silicon substrate which is commonly referred to in the industry as a “wafer”. A single wafer may, for example, contain well over 100 integrated circuit devices. When the manufacture of the integrated circuit devices on a wafer is completed, the wafer is sawn apart such that the integrated circuit devices contained thereon are separated into individual units.

It is often desirable to temporarily store integrated circuit devices and other types of electronic devices (e.g., printed circuit boards, printed wiring boards) during intermediate stages of manufacture. Such storage is often accomplished by placing the electronic devices into a magazine containing a number of individual slots, each slot being adapted to receive one electronic device. Extraction of an electronic device from its corresponding slot in the magazine is typically accomplished by hand or by using a tool such as a pair of tweezers. Damage can be caused to the electronic device when it is handled in this manner. Such damage may, for example, take the form of a die bond or wire defect.

### BRIEF DESCRIPTION OF THE DRAWINGS

FIG. 1 is a schematic top plan view of an exemplary electronic device.

FIG. 2 is a front elevation view of a portion of an exemplary magazine usable for housing electronic devices.

FIG. 3 is a front perspective view of an exemplary handling device adapted to handle an electronic device relative to a magazine.

FIG. 4 is a top plan view of an exemplary frame portion of the handling device of FIG. 3.

FIG. 5 is a top plan view of an exemplary carriage of the handling device of FIG. 3.

FIG. 6 is a front elevation view of an exemplary clip assembly of the handling device of FIG. 3.

FIG. 7 is a front perspective view schematically illustrating the handling device of FIG. 3 positioned adjacent a magazine.

FIG. 8 is a front elevation view showing the clip assembly of FIG. 6 in a closed position and in contact with an electronic device.

FIG. 9 is a front elevation view showing the clip assembly of FIG. 6 in an open position and in contact with an electronic device.

### DETAILED DESCRIPTION

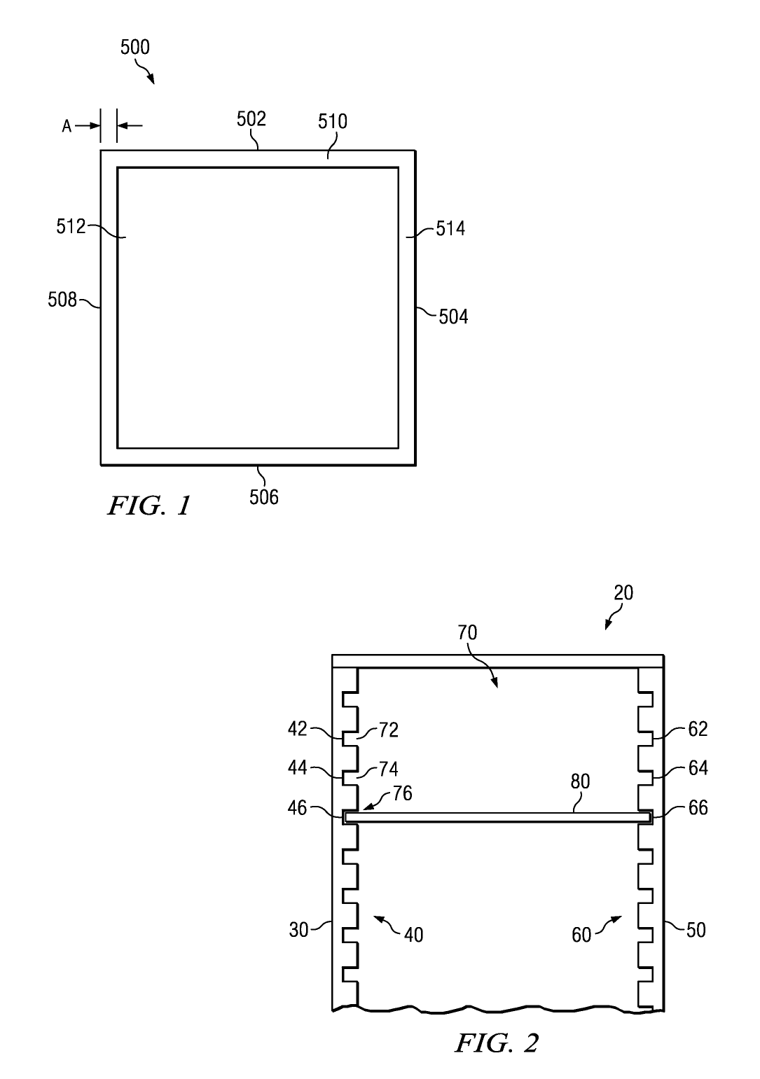

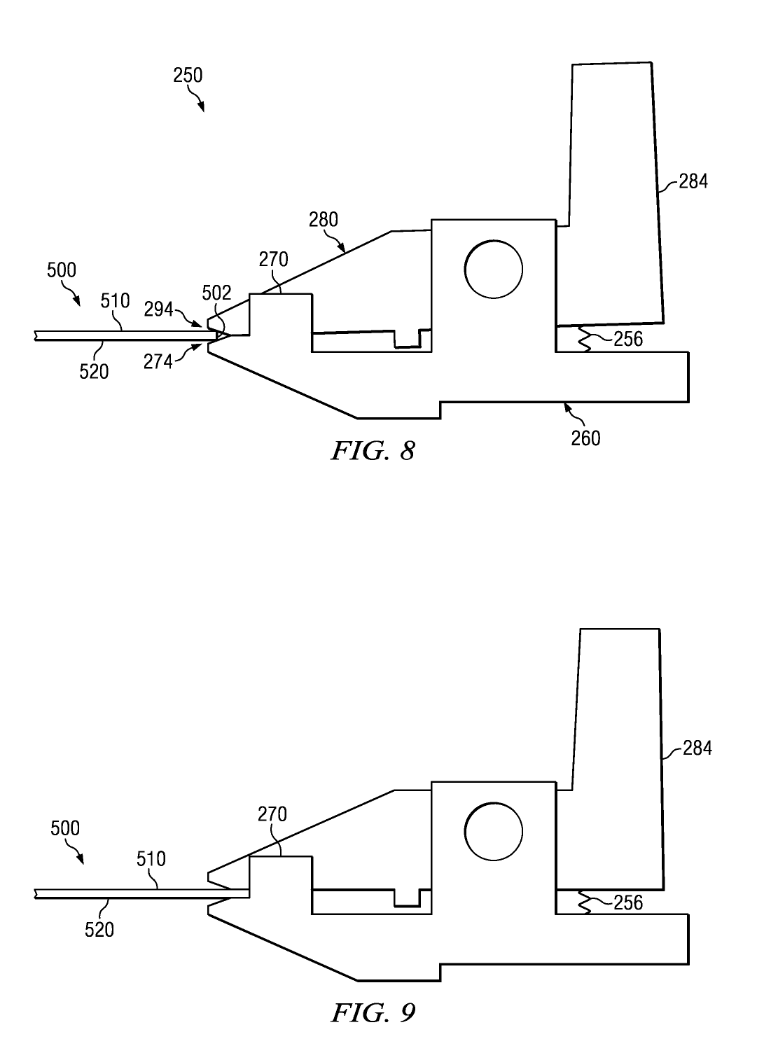

FIG. 1 illustrates an electronic device 500. The device 500 may generally include an upper surface 510 and an oppositely disposed lower surface 520 (FIG. 8). A plurality of side edges 502, 504, 506, 508 may extend between the upper and lower surfaces 510, 520. The upper surface 510 may include a central area 512 containing electronic circuitry and a peripheral area 514 (sometimes referred to as a “side rim”) that is devoid of such electronic circuitry. The electronic circuitry in the central area 512 may, for example, take the form of one or more integrated circuit devices, e.g., one or more lead frame integrated circuit devices. When handling the electronic device 500, it is desirable to only touch the peripheral area 514 in order to avoid causing damage to the electronic circuitry contained in the central area 512 since the electronic circuitry can be quite fragile and, thus, easily damaged by incidental physical contact. The peripheral area 514 may extend around the entire periphery of the electronic device, as shown, and may have a width “A”, for example, of about 1.0 mm.

FIG. 2 illustrates a portion of a magazine 20 that may be used to store electronic devices, such as the electronic device 500 described above, for example, during intermediate stages of manufacture. With reference to FIG. 2, the magazine 20 may include a pair of sidewalls 30 and 50. Each of the sidewalls 30, 50 may include a plurality of elongated grooves. More specifically, the sidewall 30 may contain the grooves 40 including, for example, the individual grooves 42, 44 and 46. The sidewall 50 may contain a plurality of grooves 60, including, for example, the individual grooves 62, 64 and 66. A plurality of slots 70, including, for example, the individual slots 72, 74 and 76, may be formed within the magazine 20. Each of the slots 70 may be defined by a pair of opposing grooves 40, 60. The slot 72, for example, may be defined by the opposing grooves 42, 62. In a similar manner, the slot 74 may be defined by the opposing grooves 44, 64 and the slot 76 by the opposing grooves 46, 66.

Each of the slots 70 is adapted to receive an electronic device. An electronic device 80, for example, is shown housed within the slot 76 of the magazine 20 in FIG. 2. The electronic device 80 may, for example, be identical to the electronic device 500, previously described with respect to FIG. 1.

As mentioned previously, damage can be caused to an electronic device when it is handled. When handling an electronic device (such as the electronic device 500, FIG. 1), it is desirable to contact the device only in the peripheral area 514, since no electronic circuitry exists in this area. Inadvertent contact (e.g., by a human hand or a tool such as a pair of tweezers) with the electronic circuitry in the central area 512, however, can easily cause damage to the electronic device. Such damage may take the form, for example, of broken and/or displaced wires and leads. Such damage often occurs when removing an electronic device from a magazine since it is difficult to limit contact with the peripheral area 14 during this operation.

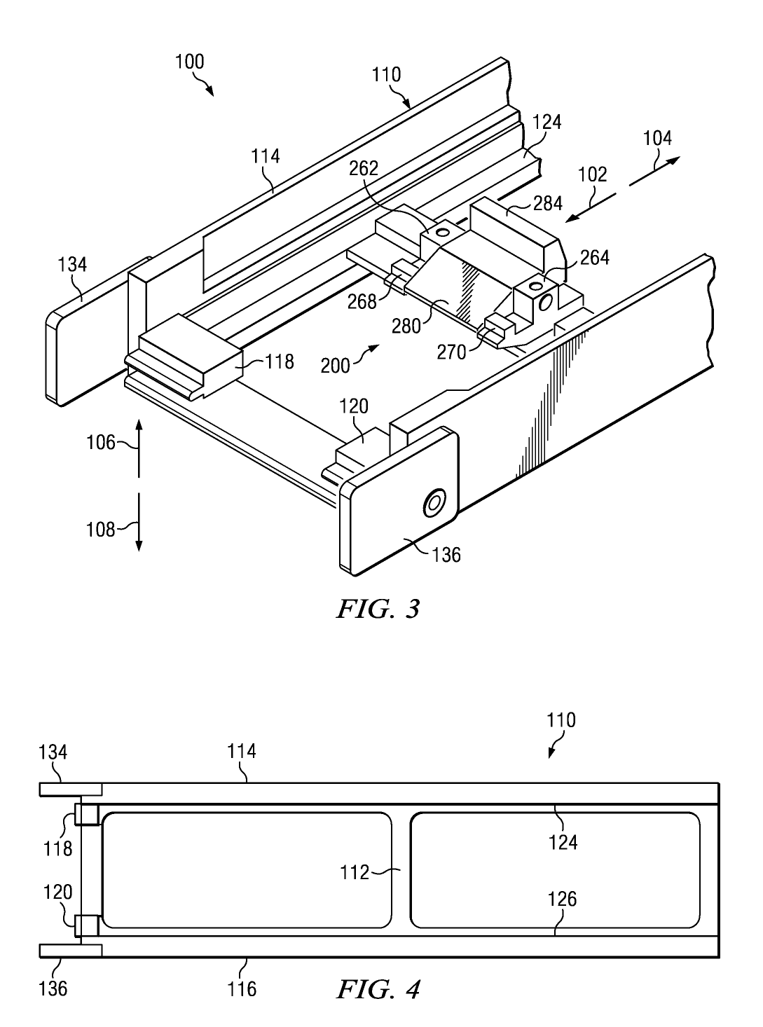

FIGS. 3-9 illustrate a handling device 100 designed to alleviate the problem discussed above. With reference, for example, to FIG. 3, the handling device 100 may generally include a frame 110 and a carriage 200 that is movably mounted on the frame 110 so as to be movable in the directions 102, 104 relative thereto.

FIG. 4 illustrates the frame 110 in further detail, with the carriage 200 removed for purposes of clarity. With reference now to FIG. 4, the frame 110 may generally include a base portion 112 and a pair of sidewalls 114, 116, extending upwardly therefrom. A pair of grooves 124, 126 may extend into the sidewalls 114, 116, respectively, as shown. A pair of side guide members 134, 136 may be attached to the forward portions of the sidewalls 114, 116, respectively. A pair of slot guide members 118, 120 may extend forwardly from the base portion 112.

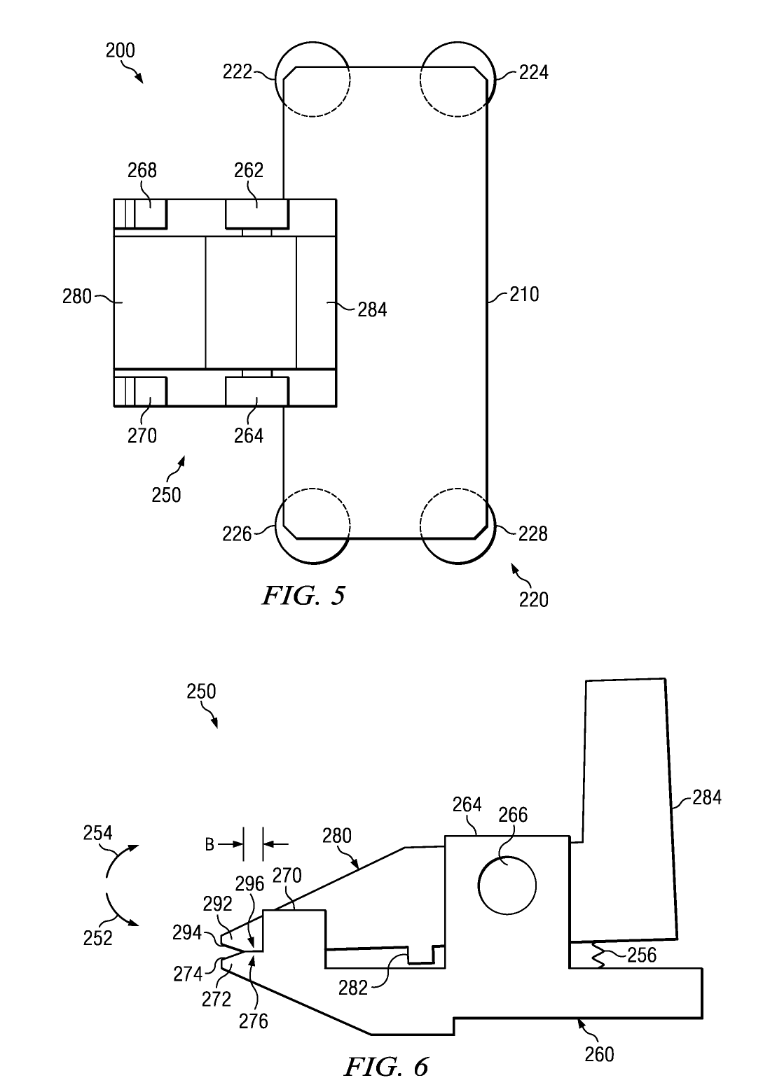

FIG. 5 illustrates the carriage 200 in further detail. With reference now to FIG. 5, the carriage may generally include a support 210 having a clip assembly 250 mounted thereon. A plurality of wheels 220, including the individual wheels 222, 224, 226, and 228, may be rotatably mounted on the under side of the support 210, as shown. When the carriage is assembled with the frame 110 as shown, for example, in FIG. 3, the wheels 222, 224 will be captured within the frame slot 124 (FIGS. 3 and 4) and the wheels 226, 228 will be captured within the frame slot 126 (FIG. 4). As can be appreciated, this arrangement allows the carriage 200 to move in the directions 102, 104 (FIG. 3) relative to the frame 110, while preventing the carriage 200 from moving in the directions 106, 108 relative to the frame 110.

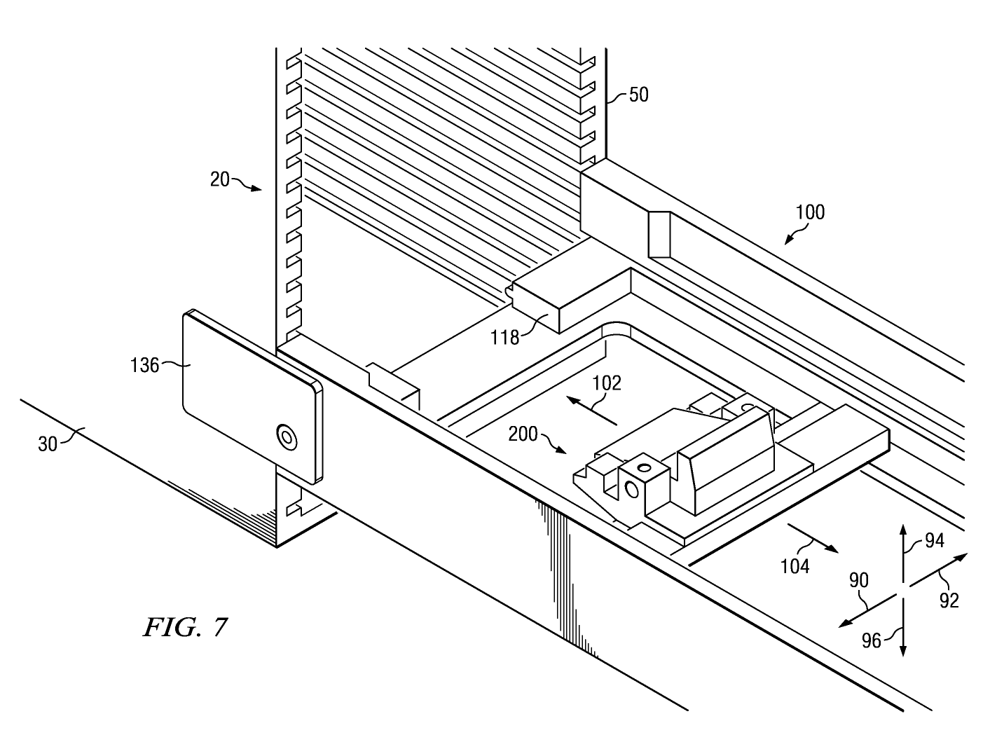

FIG. 6 illustrates the clip assembly 250 in further detail. With reference to FIG. 6, the clip assembly may generally include a base member 260 and an upper portion 280 which is pivotally mounted on the base member 260. With reference to FIGS. 5 and 6, the base member 260 may include a pair of mounting blocks 262, 264, as shown. An axle 266 may be mounted in the mounting blocks 262, 264 and extend through the upper portion 280. This arrangement allows the upper portion to pivot in the directions 252, 254, relative to the base member 260. The upper portion 280 can, for example, pivot in the direction 254 from a closed position (as shown in FIG. 6) to an open position (FIG. 9). The upper portion 280 also can pivot in the direction 252 from the open position to the closed position. A spring 256 may be provided to bias the upper portion 280 in the direction 252, i.e., toward the closed position shown in FIG. 6.

With reference again to FIGS. 5 and 6, the base member 260 may further include a pair of stop blocks 268, 270 arranged on opposite sides of the upper portion 280, as shown. With reference to FIG. 6, the upper portion 280 may include a downwardly extending projection 282. A tab 284 may extend upwardly from the upper portion 280. The tab 284 is engageable by a finger or thumb of a human user in order to facilitate pivoting the upper portion 280 in the direction 254 toward the open position. Base member 260 may include a forward portion 272 which, in turn, has a tapered surface 274 adjacent to a flat surface 276. In a similar manner, upper portion 280 may include a forward portion 292 having a tapered surface 294 and an adjacent flat surface 296. The flat surface 276 of the upper portion 280 is adapted to contact the flat surface 296 of the upper portion 280 when the clip assembly 250 is in the closed position illustrated in FIG. 6.

FIG. 7 illustrates the handling device 100 being used to remove an electronic device (e.g., the electronic device 500, FIG. 1) from a slot of the magazine 20. It is noted that the electronic device is not shown in FIG. 7 for purposes of illustrative clarity. With reference to FIG. 7, the handling device 100 may first be located adjacent the magazine 20, as shown. Specifically, the side guide members 134 and 136 may be engaged with the outer surfaces of the magazine sidewalls 50 and 30, respectively, FIGS. 2-4. As can be appreciated, this engagement prevents movement of the handling device 100 in the horizontal directions 90, 92 relative to the magazine 20 and, thus, locates the handling device 100 horizontally relative to the magazine 20.

With continued reference to FIG. 7, the handling device slot guide members 118, 120 (FIGS. 3 and 4) are engaged within the front portion of one of the slots 70 (FIG. 2) of the magazine. Specifically, the slot guide members may be engaged within the slot immediately below the slot housing the electronic device being removed. As can be appreciated, this engagement prevents movement of the handling device 100 in the vertical directions 94, 96 relative to the magazine 20 and, thus, locates the handling device 100 vertically relative to the magazine 20.

Once the handling device 100 has been located horizontally and vertically relative to the magazine 20, in a manner as described above, the carriage 200 may be advanced in the direction 102 towards the magazine 20. The carriage 200 may continue to be advanced in the direction 102 until the leading edge (e.g., the side edge 502, as illustrated in FIG. 8) of the electronic device 500 contacts the tapered surfaces 274, 294 of the clip assembly 250. FIG. 8 illustrates the arrangement when the electronic device leading edge 502 has just made contact with the clip assembly tapered surfaces 274, 294.

As can be appreciated, continued movement of the carriage 200 in the direction 102 beyond the position shown in FIG. 8 will cause the clip assembly upper portion 280 to pivot in the direction 254 (FIG. 6), against the bias of the spring 256, due to interaction between the electronic device 500 and the tapered surfaces 274, 294. This pivoting movement, in turn, allows the electronic device 500 to pass between the flat surfaces 276, 296 (FIG. 6) of the clip assembly 250 as movement of the carriage 200 continues in the direction 102. Movement of the carriage 200 in the direction 102 then may continue until the leading edge 502 of the electronic device 500 contacts the stop blocks 268, 270. This condition is illustrated in FIG. 9.

At this point, the carriage 200 may be retracted in the direction 104 in order to extract the electronic device 500 from its slot in the magazine 20. The spring 256 exerts sufficient force to ensure that friction between the electronic device 500 and the flat surfaces 276, 296 of the clip assembly 250 is sufficient to cause the electronic device 500 to move in the direction 104 along with the carriage 200. Once the carriage 200 has been retracted a sufficient amount to cause the electronic device 500 to be fully removed from the magazine 20, the human user may release the electronic device from the clip assembly 250 by engaging the tab 284 with a finger or thumb in order to pivot the upper portion 280 in the direction 254 toward the open position and, thus, release the electronic device 500 from the clip assembly 250.

The handling device 100 may also be used to install an electronic device (e.g., the electronic device 500) into a slot of the magazine 20. To do this, a human user, with the carriage 200 in a retracted position, may first engage the tab 284 with a finger or thumb in order to pivot the upper portion 280 in the direction 254 toward the open position. While holding the upper portion 280 in the open position, the user may then insert the electronic device into the open end of the clip assembly, i.e., to the position shown in FIG. 9. The user may then release the tab 284, allowing the spring 256 to bias the upper portion 280 to the closed position, thus ensuring that friction between the electronic device 500 and the flat surfaces 276, 296 of the clip assembly 250 is sufficient to retain the electronic device within the clip assembly.

Thereafter, the user may locate the handling device 100 adjacent the magazine 20 to a position as shown in FIG. 7. Specifically, in this position, the handling device slot guide members 118, 120 (FIGS. 3 and 4) are engaged within the front portion of the slot immediately below the slot where the electronic device is to be installed. As can be appreciated, this engagement prevents movement of the handling device 100 in the vertical directions 94, 96 relative to the magazine 20 and, thus, locates the handling device 100 vertically relative to the magazine 20. The handling device side guide members 134 and 136 may also be engaged with the outer surfaces of the magazine sidewalls 50 and 30, respectively, FIGS. 2-4. As noted previously, this engagement prevents movement of the handling device 100 in the horizontal directions 90, 92 relative to the magazine 20 and, thus, locates the handling device 100 horizontally relative to the magazine 20.

After the handling device is positioned relative to the magazine, in a manner as described above, the user may advance the carriage 200 in the direction 102 until the electronic device is fully housed within the desired slot of the magazine 20. Thereafter, the user may engage the tab 284, causing the clip assembly to release its grip on the electronic device, and then retract the carriage in the direction 104, leaving the electronic device housed within the magazine slot. The user may then remove the handling device from engagement with the magazine.

It is noted, with reference to FIG. 6, that the clip assembly flat surfaces 276, 296 may have a width “B” that does not exceed the width “A” of the electronic device peripheral area 514, FIG. 1. In this manner, the clip assembly physically contacts only the peripheral area 514 of the electronic device and damage to the electronic circuitry in the central area 512 of the electronic device 500 is avoided.

The foregoing description of specific embodiments has been presented for purposes of illustration and description. The specific embodiments described are not intended to be exhaustive or to suggest a constraint to the precise forms disclosed, and many modifications and variations are possible in light of the above teaching. The illustrated embodiments were chosen and described in order to best explain principles and practical application, to thereby enable others skilled in the art to best utilize the various embodiments with various modifications as are suited to the particular use contemplated. It is intended that the scope of the invention be defined only by the claims appended hereto and their equivalents, except as limited by the prior art.

What is claimed is:

1. A device for handling an electronic device relative to a magazine of the type having a plurality of slots therein, said device comprising:
a frame;
a carriage movably mounted on said frame;
a clip assembly attached to said carriage, said clip assembly adapted to frictionally engage a portion of an electronic device;
at least one slot guide member attached to said frame, said at least one slot guide member adapted to engage within one of said plurality of slots of said magazine.

2. The device of claim 1 and further wherein:
said clip assembly comprises a base member and an upper portion pivotally attached to said base member.

3. The device of claim 2 and further wherein:
said base member comprises a first contact surface;
said upper portion comprises a second contact surface; and
said first contact surface and said second contact surface are adapted to frictionally engage said portion of said electronic device therebetween.

4. The device of claim 3 and further wherein:
said electronic device comprises a central area containing easily damaged components and a peripheral area that is devoid of such easily damaged components surrounding said central area; and
said first contact surface and said second contact surface have a width not exceeding a width of said peripheral area.

5. The device of claim 2 and further wherein:
said upper portion is pivotally movable relative to said base member between a closed position and an open position; and
said device further comprises a spring member biasing said upper portion toward said closed position.

6. The device of claim 1 and further comprising:
at least one side guide member attached to said frame, said at least one side guide member adapted to engage a sidewall of said magazine.

7. The device of claim 1 and further comprising:
a stop member attached to said clip assembly, said stop member adapted to contact an edge surface of said electronic device when said clip assembly is frictionally engaging said portion of said electronic device.

8. A method of handling an electronic device relative to a magazine of the type having a plurality of slots therein, said method comprising:
providing a handling device comprising:
a frame;
a carriage movably mounted on said frame;
a clip assembly attached to said carriage, said clip assembly adapted to frictionally engage a portion of an electronic device;
at least one slot guide member attached to said frame;
positioning said handling device adjacent said magazine;
engaging said at least one slot guide member within one of said plurality of slots of said magazine in order to locate said handling device relative to said magazine.

9. The method of claim 8 and further comprising:
advancing said carriage toward said magazine after said handling device is located relative to said magazine;
frictionally engaging said portion of said electronic device with said clip assembly; and
retracting said carriage, along with said electronic device, away from said magazine.

10. The method of claim 9 and further wherein:
said clip assembly comprises a base member and an upper portion pivotally attached to said base member;
said base member comprises a first contact surface;
said upper portion comprises a second contact surface; and
wherein said frictionally engaging said portion of said electronic device with said clip assembly comprises frictionally engaging said portion of said electronic device with said first contact surface and said second contact surface.

11. The method of claim 10 and further wherein:
said electronic device comprises a central area containing easily damaged components and a peripheral area that is devoid of such easily damaged components surrounding said central area; and
said frictionally engaging said portion of said electronic device with said first contact surface and said second contact surface comprises frictionally engaging only said peripheral area of said electronic device with said first contact surface and said second contact surface.

12. The method of claim 10 and further wherein:
said upper portion is pivotally movable relative to said base member between a closed position and an open position; and
said frictionally engaging said portion of said electronic device with said clip assembly comprises pivoting said upper portion to said open position.

13. The method of claim 12 and further comprising:
biasing said upper portion toward said closed position with a spring member.

14. The method of claim 8 and further wherein:
said handling device further comprises at least one side guide member attached to said frame; and
said positioning said handling device adjacent said magazine further comprises engaging a sidewall of said magazine with said side guide member.

15. A device for handling an integrated circuit device of the type having a central area containing easily damaged components and a peripheral area that is devoid of such easily damaged components surrounding said central area, said device comprising:
a clip assembly movably between an open position and a closed position, said clip assembly having at least one surface adapted to frictionally engage said integrated circuit device; and
wherein, said at least one surface has a length not exceeding a length of said peripheral area of said electronic device.

16. The device of claim 15 and further wherein:
said clip assembly comprises a base member and an upper portion pivotally attached to said base member.

17. The device of claim 16 and further wherein:
said base member comprises a first contact surface;
said upper portion comprises a second contact surface;
said at least one surface comprises said first contact surface and said second contact surface; and
said first contact surface and said second contact surface are adapted to frictionally engage at least a portion of said electronic device peripheral area therebetween.

18. The device of claim 15 and further comprising:
a frame;
a carriage movably mounted on said frame; and
wherein said clip assembly is attached to said carriage.

19. The device of claim 18 and further comprising:
at least one slot guide member attached to said frame, said at least one slot guide member adapted to engage within one of said plurality of slots of a magazine adapted to house said electronic device.

20. The device of claim 19 and further comprising:
at least one side guide member attached to said frame, said at least one side guide member adapted to engage a sidewall of said magazine.
